(19) United States
(12) Patent Application Publication
(10) Pub. No.: US 2004/0264709 A1
(43) Pub. Date: Dec. 30, 2004

(54) Reduced stress taxi cab

(76) Inventor: Eyal Yona, Carme Yosef (IL)

Correspondence Address: DR. MARK FRIEDMAN LTD., C/o Bill Polkinghorn, Discovery Dispatch, 9003 Florin Way, Upper Marlboro, MD, 20772, US

(21) Appl. No.: 10/456,514

(22) Filed: Jun. 9, 2003

(51) Int. Cl. H04B 1/00

(52) U.S. Cl. 381/86

(57) ABSTRACT

A device for reducing-stress during travel is provided, namely a motor vehicle having an entertainment system controlled by the passenger. Also, a method of providing hired transport services is provided where a motor vehicle, such as a taxi cab, is provided having a passenger controlled entertainment system.

### FIELD AND BACKGROUND OF THE INVENTION

The present invention relates to the fields of transportation and tourism and specifically to a motor vehicle having a passenger controlled entertainment system.

Taxi cabs are well-known features of modern urban settings. People who hire taxi cabs, the passengers, often find themselves in a cab for an extended period of time whether because a specific trip is very long or due to traffic jams. The long period of time in which a passenger is found in a taxi cab is a source of irritation.

A variety of devices have been installed in motor vehicles to allow the driver to make these extended periods of time more enjoyable. Such devices include radio receivers and audio players such as cassette tape players, 8-track tape players and compact disk players. These devices are under control of the driver, the person invariably found in a motor vehicle. However, the fact that the driver controls the choice of music rarely assuages the irritation of a passenger.

It would be highly advantageous to have a device that provides added-value to a taxi-cab passenger in the form of a passenger-controlled entertainment system.

### SUMMARY OF THE INVENTION

The above and other objectives are achieved by the present invention.

According to the teachings of the present invention there is provided a device exceptionally useful for use as a taxi-cab comprising a motor vehicle having an entertainment system, a driver position and at least one passenger position and a control system to control the entertainment system, wherein the control system is operable by a person (the passenger) located at the at least one passenger position.

According to a feature of the present invention, the entertainment system includes at least one of the devices from a group consisting of audio playback devices, audiovisual playback devices, two-way wireless communication devices, geographical location indication devices and goods/services information devices.

According to a further feature of the present invention, the device also includes an activation switch for the entertainment system, the activation switch having at least two states, a first state where said entertainment system is activated for operation by the passenger; and a second state where the entertainment system is inactivated for operation by the passenger and a payment collection device, configured to toggle the activation switch from the second state (inactivated) to the first state (activated) upon collection of a payment. In such a way, a passenger can use the entertainment system only upon payment of a fee.

According to a still further feature of the present invention, the device also includes a passenger door switch, configured to toggle the switch device from the first state (activated) to the second state (inactivated) when a passenger door is opened. In such a way, the entertainment system is reset every time a passenger leaves and every succeeding passenger must pay in order to use the entertainment system.

There is also provided according to the teachings of the present invention a method of providing transport services comprising offereing for hire a device as described above (a motor vehicle with passenger-operated entertainment system) together with a driver, in the manner of a taxi cab.

### BRIEF DESCRIPTION OF THE DRAWINGS

The invention is herein described, by way of example only, with reference to the accompanying drawings, wherein:

FIG. 1 is a partially cut-out top view of a device of the present invention.

### DETAILED DESCRIPTION OF THE INVENTION

The present invention is of a device that includes a motor vehicle wherein a entertainment system operable by a passenger, as opposed to a driver, is installed in the motor vehicle. Such a motor vehicle is exceptionally suited for use as a taxi-cab. The present invention is also of a method for operating a business of supplying motor vehicles for hire. Since the added value provided by a device of the present invention is so high, a typical customer of taxi cabs will be interested in paying a premium for a business operating according to the teachings of the present invention.

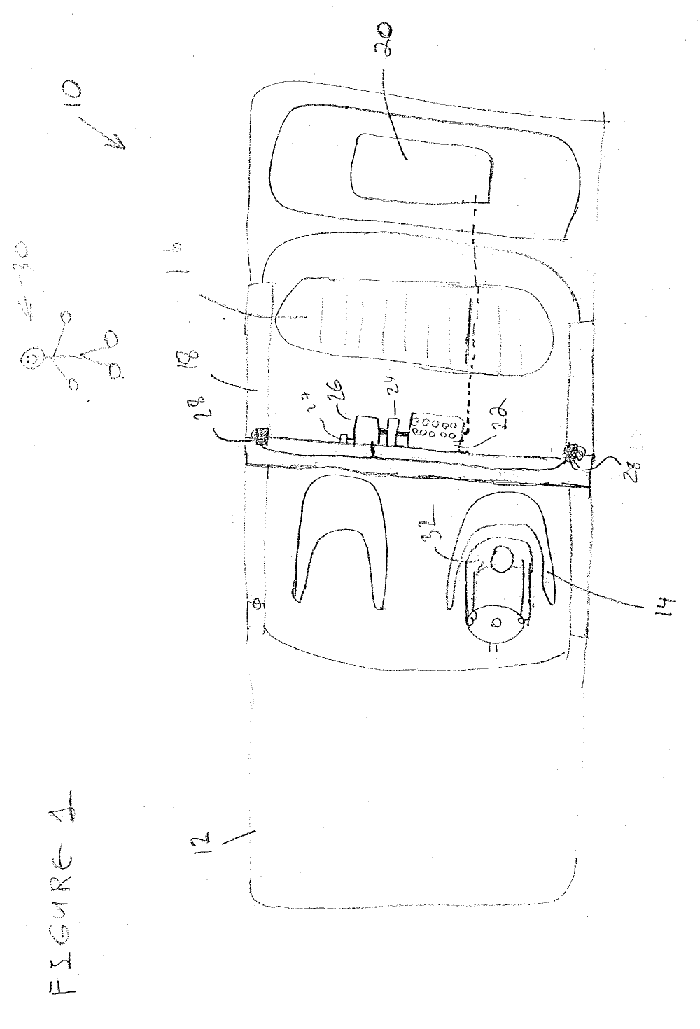

In FIG. 1 a device 10 of the present invention is depicted, a motor vehicle 12 having a driver position 14, a passenger position 16 and a passenger door 18. Device 10 is depicted from a top-view where the roof and trunk cover of motor vehicle 12 have been removed to allow a view into the internal volume of motor vehicle 12. Device 10 is equipped with a entertainment system 20 (in FIG. 1, a compact disc player having a magazine of twelve compact discs) an entertainment system controller 22, an activation switch 24, a payment collection device 26 and a passenger door switch 28.

Activation switch 24 has at least two states: a first state where entertainment system 20 and entertainment system controller 22 are activated for operation by the passenger and a second state where entertainment system 20 and entertainment system controller 22 are inactivated for operation by the passenger.

Payment collection device 26 is similar to prior art payment collection devices as often implemented in pay phones, parking payment devices and the like. Payment collection device 26 is configured to accept payment according to some method. Payment methods known in the art and which are exceptionally suitable for implementation in the present invention include but are not limited to coins, bills, debit cards, credit cards, punch cards and tokens. Payment collection device 26 is configured, upon receipt of sufficient payment, to toggle activation switch 24 from the second state where entertainment system 20 and entertainment system controller 22 are inactivated for operation by the passenger to the first state where entertainment system 20 and entertainment system controller 22 are activated for operation by the passenger.

In some embodiments of the present invention payment collection device 26 is equipped with a timer 27. Timer 27 acts as a prior-art time meter and causes collection device 26 to toggle activation switch 24 from the first (activated) state to the second (inactivated) state after a certain period of time, where the period of time is determined by the amount of payment.

Passenger door switch 28 is connected to payment collection device 26. Passenger door switch 28 is configured so as to detect if passenger door 18 is opened. If passenger door 18 is opened, passenger door switch 28 sends a signal to payment collection device 26 indicating that payment is insufficient. As a consequence, when passenger door 18 is opened, payment collection device 26 causes activation switch 24 to toggle to the second state where entertainment system 20 and entertainment system controller 22 is activated for operation.

Operation of device 10 is as follows. A person 30 interested in hiring a taxi cab, hails device 10. A taxi cab driver 32 sitting in driver position 14 stops device 10 and allows person 30 to board through passenger door 18 and to sit in passenger position 16. While riding in device 10, person 30 notices entertainment system controller 22. Person 30 pays a required sum using payment collection device 26, causing activation switch 24 to toggle to the first state where entertainment system 20 and entertainment system controller 22 are activated for operation. Person 30 proceeds to use entertainment system controller 22 to select music to be played by entertainment system 20 listen to while riding in device 10. In such a way person 30 is entertained while riding and the travel with device 10 is a positive and calming experience.

It is clear to one skilled in the art that entertainment system 20 can be implemented as any one of the devices known in the art and is not limited to a compact device player as depicted in FIG. 1. A partial non-limiting list of devices that can be used to implement the entertainment system of the present invention include audio playback devices such as tape players, compact disk players, mini-disk players and MP3 players. Also useful in implementing the entertainment system of the present invention are audiovisual playback devices such as television receivers, video players, DVD players or interactive audiovisual playback devices (“video games”). Also useful in implementing the entertainment system of the present invention are two-way wireless communication devices such as internet communication devices and electronic mail communication devices. Also useful in implementing the entertainment system of the present invention are geographical location indication devices such as global-positioning system satellite receivers. Also useful in implementing the entertainment system of the present invention are goods/services information devices such as tour guides, telephone/address directories and events directories.

The use of the device of the present invention allows for an improved method of running a transport service hiring business. In general, transport service hiring businesses are based on providing a motor vehicle and driver for hire. The added value of the entertainment system makes it so that potential passengers prefer to be clients of a taxi cab business providing a device of the present invention for hire instead of a prior art motor vehicle. In addition, such a transport service hiring business has an added source of income when providing a device of the present invention for hire.

The present invention is not limited to the embodiment described herein but also relates to all kinds of modifications thereof, insofar as they are within the scope of the claims.

1. A device comprising:
a. a motor vehicle having an entertainment system, a driver position and at least one passenger position; and
b. an entertainment control system to control said entertainment system wherein said entertainment control system is operable by a person located at said at least one passenger position.

2. The device of claim 1 wherein said entertainment system comprises at least one of the devices from a group consisting of audio playback devices, audiovisual playback devices, two-way wireless communication devices, geographical location indication devices and goods/services information devices.

3. The device of claim 1 further comprising:
c. an activation switch for said entertainment system having at least two states,
i. a first state where said entertainment system is activated for operation by said person; and
ii. a second state where said entertainment system is inactivated for operation by said person
d. a payment collection device, configured to toggle said switch device from said second state to said first state upon collection of a payment.

4. The device of claim 3 further comprising:
e. a passenger door switch, configured to toggle said activation switch from said first state to said second state when a passenger door is opened.

5. A method of providing transport services comprising
a. providing a device of claim 1;
b. providing a driver for said device; and
c. offering said device with said driver for hire.
